(19) United States
(12) Patent Application Publication
(10) Pub. No.: US 2005/0092589 A1
(43) Pub. Date: May 5, 2005

(54) Electrical box

(76) Inventor: Raymond Leonard Conway, Batavia, OH (US)

Correspondence Address: RAYMOND L. CONWAY, 4490 Stratford Ct., Batavia, OH, 45103, US

(21) Appl. No.: 10/700,123

(22) Filed: Nov. 3, 2003

(51) Int. Cl. H01H 9/02

(52) U.S. Cl. 200/300

(57) ABSTRACT

An electrical box suitable for safely and efficiently housing an electrical connection. The electrical box comprises a bottom and a plurality of adjacent side walls, each side wall being at least partially joined to the bottom and to each adjacent side wall to form an open box. Each side wall has a top edge wherein the top edges define an open box perimeter. A top is hingedly joined to one the top edges of one the side walls and is adapted to be moveable from an open position to a closed position. At least one the side walls comprises at least one conductor opening. The conductor opening is adjacent to and includes the top edge of the side wall and is adapted to receive at least one of the electrical conductors, the conductor opening being at least partially defined by the top when the top is in the closed position.

### FIELD OF THE INVENTION

The invention relates to electrical boxes for housing electrical connections.

### BACKGROUND OF THE INVENTION

Electrical boxes for making safe and secure electrical connections are known. For example, metal or plastic boxes, often known as junction boxes, are often used to make connections of household wiring. Known boxes for this purpose often have predetermined openings in the sides that can be removed to permit entry of wiring to be connected. These openings may be formed by removing a portion of the side, so called “knock outs”, or they may be made by deforming a portion of the box side to bend about a hinge line, thereby defining an opening in which wiring or cables can enter the box. Once the conductors to be connected have each entered the interior of the box via one or more of the predetermined openings, the connection can be made, the box cover placed on and secured, and the connection is complete.

One of the drawbacks with current boxes is the relative difficulty in facilitating entry of the conductors into the box. Often the portion of the side wall of the box to be removed must be knocked out with a tool such as a hammer. Often it must be pried out with a tool such as a screw driver. This can be especially difficult with metal boxes, for example.

Another drawback with current boxes is that the top, or lid, is easy to misplace, or forget when doing an electrical connection. For example, an electrician making connections in an attic may forget to bring along the top to a junction box, thereby necessitating an inconvenient and time-consuming trip out of the attic to retrieve the top.

Accordingly, there is a need for an electrical box, e.g., improved junction box, for making electrical connections that minimizes or eliminates the need to remember the top with each junction box.

Additionally, there is a need for an electrical box that is adapted to permit the making of electrical connections faster and easier within the box.

### SUMMARY OF THE INVENTION

An electrical box suitable for safely and efficiently housing an electrical connection is disclosed. The electrical box comprises a bottom and a plurality of adjacent side walls, each side wall being at least partially joined to the bottom and to each adjacent side wall to form an open box. Each side wall has a top edge wherein the top edges define an open box perimeter. A top is hingedly joined to one the top edges of one the side walls and is adapted to be moveable from an open position to a closed position. At least one the side walls comprises at least one conductor opening. The conductor opening is adjacent to and includes the top edge of the side wall and is adapted to receive at least one of the electrical conductors, the conductor opening being at least partially defined by the top when the top is in the closed position.

### BRIEF DESCRIPTION OF THE DRAWINGS

FIG. 1 is a perspective view of one embodiment of an electrical box of the present invention.

FIG. 2 is a perspective view of another embodiment of an electrical box of the present invention.

FIG. 3 is a detail view of an optional configuration for an opening in an electrical box of the present invention.

### DETAILED DESCRIPTION OF THE INVENTION

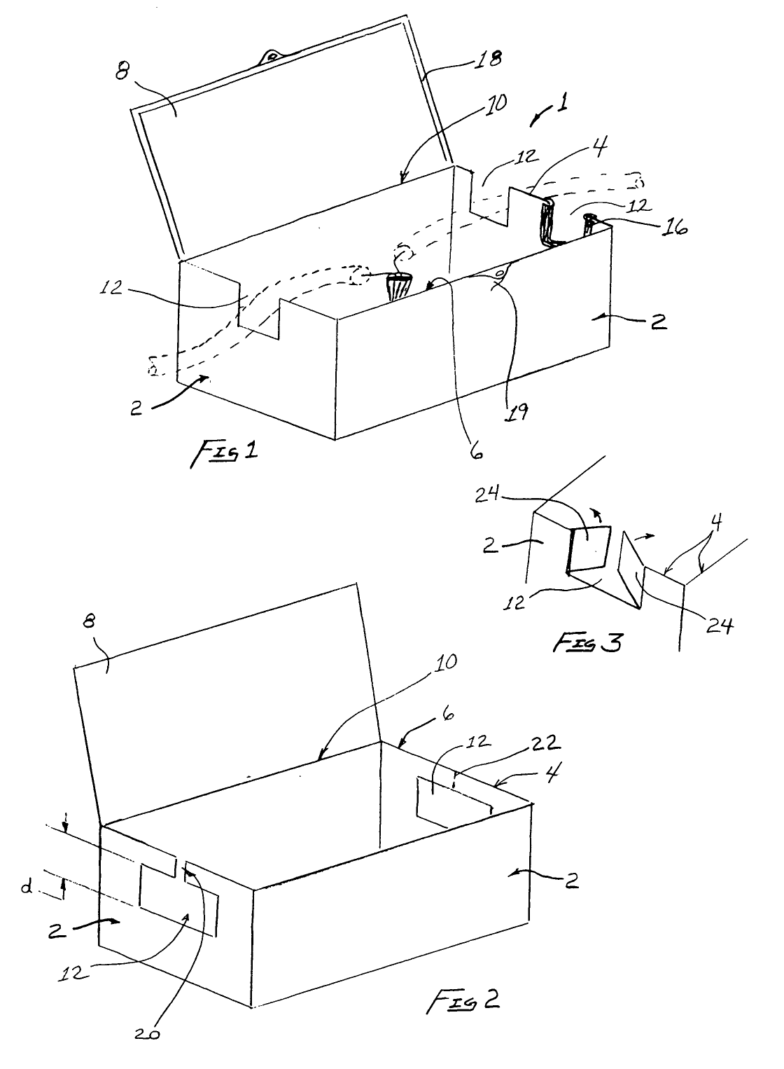

One embodiment of an electrical box of the present invention is shown in FIG. 1. As shown, box 1 has side walls 2 joined to a bottom, which together form an open container. Although FIG. 1 shows a typical arrangement of four side walls 2 forming a rectangular box, the invention is not limited only to such a typical configuration. In general, any configuration of three or more side walls 2 will suffice. The top edges 4 of side walls 2 define a peripheral open edge 6 of the open container. Top 8 is hingedly joined at hinge 10 to one of the top edges 4, such that the top 8 can close shut, substantially sealing the container about the peripheral open edge 6. A notch or cut-out portion of the top edge 4 of at least one side wall 2 defines a conductor opening 12 adapted to receive at least on conductor, as shown in dotted line in FIG. 1, but it is understood that the conductors shown do not forming a part of the invention. A connection can be made inside the box, as represented in dotted lines in FIG. 1 by two conductors joined by a typical wire nut, and the top closed such that the connection is safely and efficiently housed within box 1.

Although FIG. 1 shows two openings 12, one on each of two opposing side walls 2, there could be more, and only one is necessary for the present invention. For example, both conductors to be connected can be placed into the box 1 via one opening 12 and still enjoy the advantages of the present invention. Likewise, although the openings 12 are shown in FIG. 1 as being substantially rectangular in shape, the shape is not determinant of the invention. For example, the shape of conductor opening(s) 12 can be practically any geometric shape, and can be shaped to fit specific cross-sectional sizes of specific conductors. Further, it is contemplated that the conductor opening(s) 12 of the present invention can be fitted with suitable grommets or pliable seals to provide a weatherproof fitting at the conductor openings, as well as providing for some strain relief on the conductors. For example, as shown in FIG. 1, a substantially “U”-shaped seal 16 can be suitably fitted to the edges of conductor opening 12 by methods known in the art, such as by press fitting about a longitudinal groove in seal 16. Once top 8 is shut, optional sealing gasket member 18 can complete the seal about conductor opening 12 to provide for a weatherproof enclosure. Of course, any known sealing material, such as rubber, neoprene, polymeric elastomer materials, or other polymeric or pliable materials can be used for seal 16 or gasket member 18. Likewise, any suitable shape and size of seal 16 can be incorporated for proper sealing properties. In fact, a generally circular, or other closed shape of seal can be used, recognizing that such a seal would necessarily need to be fitted onto the electrical conductor prior to making an electrical connection inside the box. The closed shape seal then could be appropriately positioned along the length of the electrical conductor until it coincided with opening 12 to make a weather proof seal after closing top 8.

Top 8 can be a separate member attached by a hinge connection to one of side walls 2. For example, top 8 can be joined by a “piano” hinge. However, in a preferred embodiment, top 8 is integral with the side wall 2 to which it is joined. In a preferred embodiment, the bottom 12, side walls 2, and top 8 are molded of impact resistant plastic material as a unitary structure, with hinge 10 being a living hinge. As such, the electrical box 1 of the present invention can be substantially molded in one piece, in a single mold. The box 1 can be molded by methods known in the art for producing molded articles. Top 8 can be retained in the shut position by methods known in the art. For example, top 8 can be held closed by any number of known snap connections, screw connections, e.g., screw connection 19, or simply by friction and force fit.

Other known variations can be made to a box of the present invention without departing from the scope of the invention. For example, strain relief clamps can be positioned appropriately so as to provide for strain relief on the cables. In one embodiment, screw-down strain relief clamps as known in the art can be molded or otherwise joined to the outside of box 1 such that once the conductors are connected in the box 1, the clamps are screwed tight to secure the conductors from undesirable tension on the connection. Further, various mounting means, such as screw holes, nail guides, brackets and the like, as are known in the art for mounting to joists and the like, can be utilized with box 1. In general, therefore, any of known modifications to current electrical or junction boxes can be made to the box of the present invention.

As can be appreciated by the skilled person, the advantages of the present invention are many. For example, since prior to closing the top 8 conductor opening 12 is partially defined by the top edge 4 of side wall 2, the conductor to be connected can enter the box across the top edge 4 of side wall 2. That is, there is no need to feed the conductor(s) through a hole in the side of the box, but the conductors can simply be “laid in” so to speak. This greatly simplifies the job of making electrical connections. In fact, connections can be made prior to putting the connected conductor ends into the box. This permits an electrician, for example, to make connections in the open, then fit them into what can be a relatively confined area of the electrical box 1.

Another advantage of the electrical box 1 of the present invention is the hingedly joined top 8. By being joined hingedly, top 8 is essentially one piece with electrical box 1, so that the top 8 is always with box 1 and does not get lost or misplaced. This can save much time and effort, for example when an electrician is working in the attic of a house making electrical connections. He or she need not need to remember to carry multiple parts to make a safe, complete connection. The hingedly-joined top 8 is particularly beneficial when hinge 10 is a living hinge, as this greatly simplifies production of the box 1. As is known in the art, a living hinge is integrally molded with the parts to be hinged together, the hinge simply being a thinned portion of the molded article. When a living hinge is utilized, therefore, box 1 can simply be molded by known means a one piece, with an integrally-hinged top.

Other variations are contemplated for the present invention. For example, as shown in FIG. 2, conductor openings 12 can be offset from top edge 4 of side wall 2 by a predetermined distance d, with a means for conductor access to the opening 12 for example, as shown on one side wall 2 of in FIG. 2, a slot 20 joins the top edge 4 of side wall 2 to opening 12. As shown on another side wall 2 of the electrical box 1 in FIG. 2, a frangible portion 22 is provided, which can be frangibly separated to form an open pathway to opening 12. Frangible portion 22, can be, for example, a thinned portion of side wall 2, or a perforated portion of side wall 2. As such, a simple twisting or tearing motion by a user can break frangible portion 22 to separate respective portions of side wall 2 to make an open pathway to opening 12 (similar to channel 20, discussed above).

The advantage of the embodiment shown in FIG. 2 is that the relatively constricted channel 20, or opened frangible portion 22, can help hold electrical conductors in place in the electrical box 1 prior to closing top 8. Therefore, the conductors are relatively constrained and cannot readily come out of the box 1 while the electrician is doing other things prior to finishing the connection of the electrical conductors.

In either of the illustrated embodiments, opening 12 can be provided as-is as an actual opening, or it can be provided as an “openable” opening. That is, as shown in a detail of an embodiment of an opening 12 in FIG. 3, opening 12 can be formed by, for example, deformable plastic members 24 that can be biased into an open position. Therefore, opening 12 is provided for in a closed condition, but is openable by, for example, folding deformable plastic members 24 inwardly as shown in FIG. 3. Deformable plastic members 24 can be hingedly joined to edges of opening 12 and/or can be frangible members that can be removed prior to placing the conductor into opening 12. Deformable plastic members 24 can provide some sealing and strain relief functions.

1. An electrical box suitable for safely and efficiently housing an electrical connection, the electrical connection being made between at least two electrical conductors, said electrical box comprising:
a bottom;
a plurality of adjacent side walls, each said side wall being at least partially joined to said bottom and to each adjacent side wall to form an open box, each said side wall having a top edge wherein the top edges define an open box perimeter;
a top hingedly joined to one said top edge of one said side wall and adapted to be moveable from an open position to a closed position;
at least one said side wall comprising at least one conductor opening, said conductor opening being adjacent to and including said top edge of said side wall to receive at least one of the electrical conductors, said conductor opening being at least partially defined by said top when said top is in said closed position; and wherein said conductor opening comprises frangible portions.

2. The electrical box of claim 1, wherein said top is unitary with said top edge of said side wall.

3. The electrical box of claim 1, wherein said top is hingedly joined by a living hinge.

4. (canceled)

5. The electrical box of claim 1, wherein said conductor opening comprises a pliable seal.

6. (canceled)

7. The electrical box of claim 1, wherein said top comprises a pliable seal to at least partially seal said open box perimeter when said top is in a closed position.

8. An electrical box suitable for safely and efficiently housing an electrical connection, the electrical connection being made between at least two electrical conductors, said electrical box comprising:
a bottom;
a plurality of adjacent side walls, each said side wall being joined to said bottom and to each adjacent side wall to form an open box, each said side wall having a top edge wherein the top edges define an open box perimeter;
a top hingedly joined to one said top edge of one said side wall and adapted to be moveable from an open position to a closed position;
at least one said side wall comprising at least one conductor opening, said conductor opening being offset from a top edge of said side wall;
a frangible member to permit access from said top edge of said side wall to said conductor opening, such that at least one of the electrical conductors can be placed into said conductor opening via said access.

9. (canceled)

10. (canceled)

11. The electrical box of claim 8, wherein said top is unitary with said top edge of said side wall.

12. The electrical box of claim 8, wherein said top is hingedly joined by a living hinge.

13. The electrical box of claim 8, wherein said conductor opening comprises a pliable seal.

14. (canceled)

15. The electrical box of claim 8, wherein said top comprises a pliable seal to at least partially seal with said open box perimeter when said top is in a closed position.
